(19) United States
(12) Patent Application Publication
(10) Pub. No.: US 2022/0134144 A1
(43) Pub. Date: May 5, 2022

(54) FACE PROTECTION MASK

(71) Applicant: Marcello Massimiliano BALESTRA, Torino (IT)

(72) Inventors: Marcello Massimiliano BALESTRA, Torino (IT); Mattia BERRONE, Torino (IT)

(73) Assignee: Marcello Massimiliano BALESTRA, Torino (IT)

(21) Appl. No.: 17/453,267

(22) Filed: Nov. 2, 2021

(30) Foreign Application Priority Data
Nov. 3, 2020 (IT) 202020000006157

(51) Int. Cl. A62B 23/02; A41D 13/11; A62B 18/08

(52) U.S. Cl. CPC A62B 23/025; A62B 18/084; A41D 13/11

(57) ABSTRACT

Face protection mask comprising a flexible filtering screen shaped to cover the mouth and nose of the user. The mask incorporates an adhesive element projecting from the upper edge of the filtering screen and forming a flexible appendage configured to cover—in use—a substantial portion of the nose of the user, adhering thereto.

### FIELD OF THE INVENTION

The present invention relates to face protection masks which have by now become a personal protection equipment indispensable for reducing exposure to viruses and bacteria, as well as to particulates.

### STATE OF THE PRIOR ART

Masks thus made, whether of the disposable and washable surgical type and also of the FFP type with stronger filtration, conventionally consist of a flexible filtering screen shaped to cover the mouth and nose of the user and provided with lateral elements for attaching to the ears or behind the nape, typically consisting of elastic bands or straps.

All masks currently available share a common problem: the adhesion of the upper part to the face is on the one hand insufficient and feeble, and on the other hand it is a source of discomfort for users wearing eyeglasses. As a matter fact, even if the mask is provided—in the central part of the upper edge of the filtering screen—with an element in the form of a piece of iron that can be plastically modelled astride the nasal bone, the adhesion is still imperfect due to the more or less large slits that normally remain on the sides of the nose and beyond. Through these slits the inhalation of the user can convey the ambient air into the mask, and exhalation can cause fogging on the glasses lenses by the vapour emitted by the mouth and nose, which exits upwards against the inner surfaces of the lenses instead of passing through the filtering screen of the mask.

In order to overcome this drawback, masks provided with an inner adhesive strip suitable to improve the adhesion to the nose of the user below the upper edge of the filtering screen provided have been proposed. Examples of these solutions are described and illustrated for example in documents CN 111248544A, CN111096503A and JP 3112111U.

These solutions have not proved satisfactory either, given that, while reducing them, they do not solve the problem mentioned above to a satisfactory extent.

### SUMMARY OF THE INVENTION

Therefore, the object of the present invention is to provide a face protection mask which allows the user thereof to effectively and fully avoid these drawbacks.

According to the invention, this object is achieved thanks to the fact that the filtering screen of the mask is provided with an adhesive element projecting from upper edge thereof and forming a flexible appendage configured to cover—in use—a substantial portion of the nose of the user, adhering thereto.

The adhesive element conveniently has the consistency and characteristics of a medical patch and, similarly to the latter, it is protected by peel-off films prior to applying the mask.

In the case of surgical masks, whose filtering screen usually consists of at least three superimposed layers, the adhesive element is inserted and fixed by adhesion between these layers.

### BRIEF DESCRIPTION OF THE DRAWINGS

The invention will now be described in detail, purely by way of non-limiting example, with reference to the attached drawings, wherein:

FIG. 1 is a schematic perspective view of a face mask made according to the invention,

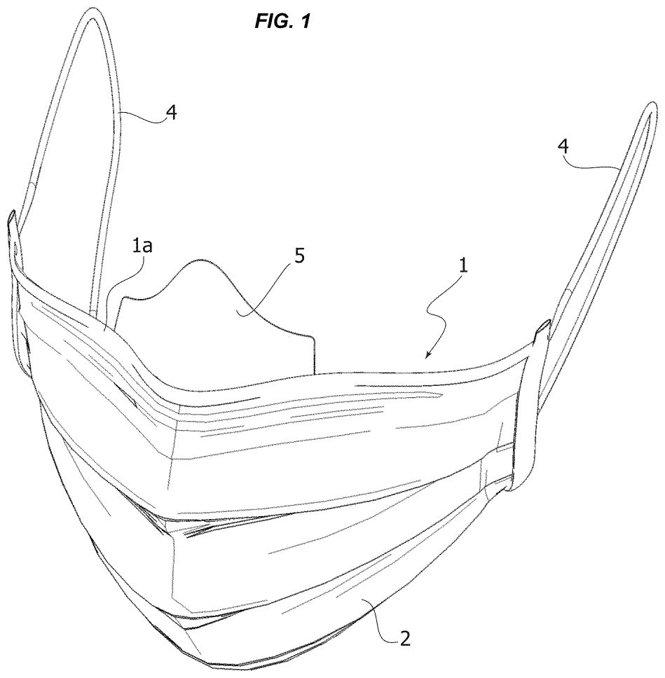

FIG. 2 is a front elevational view of the mask,

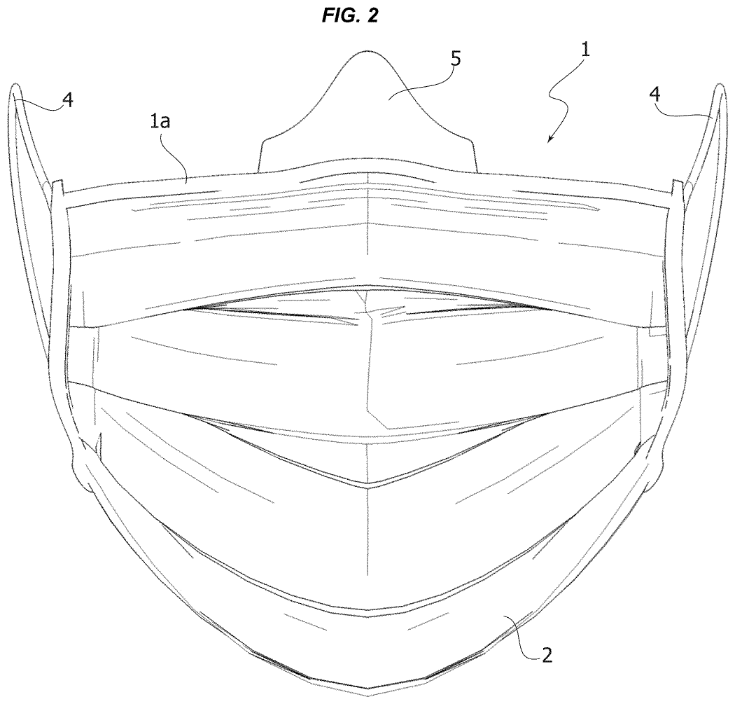

FIG. 3 is a rear view of the mask, and

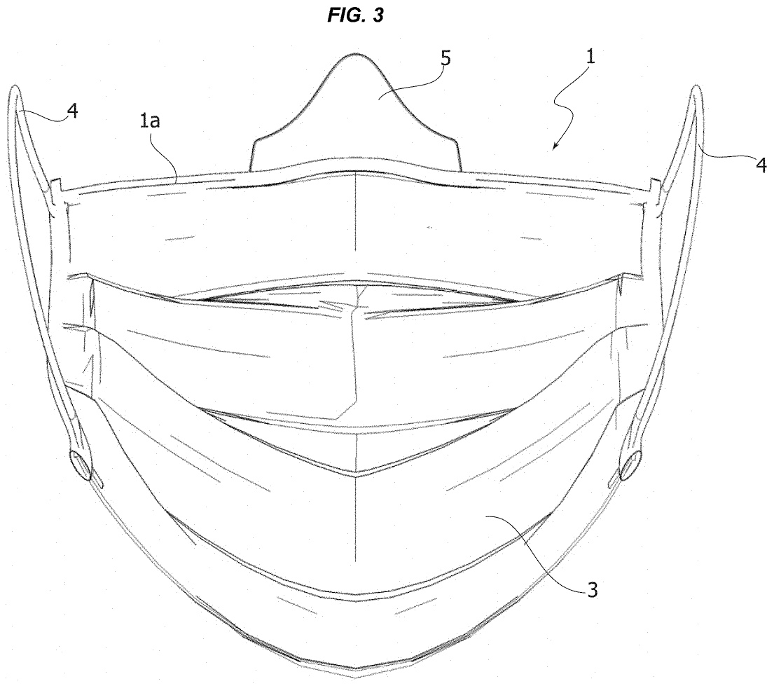

FIG. 4 is a side elevational view of the mask.

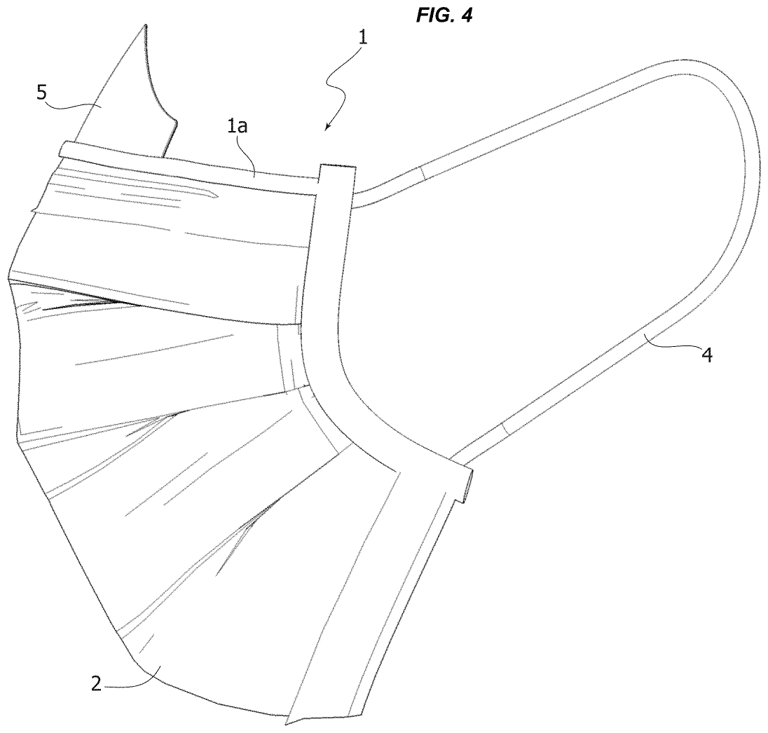

### DETAILED DESCRIPTION OF THE INVENTION

The embodiment shown in the drawings relates to a disposable surgical filtering face mask. However, it should be observed that the invention can be applied equally usefully to face masks of any type, for example the ones referred to as FFP.

The mask conventionally consists of a flexible and permeable screen 1 with shape and size such to cover—in use—the face of the user in the mouth and nose regions. The screen 1 typically consists of three superimposed layers respectively outer 2 made of non-woven fabric (for example polypropylene), inner layer 3 also made of non-woven fabric (for example polypropylene), and an intermediate layer not visible made of high-density filtering material. The three layers are pleated, so as to make the screen 1 extensible height-wise, and they are joined peripherally to each other, for example by means of heat sealing or other conventional joining systems.

The upper edge 1a of the screen 1 can centrally incorporate a piece of iron, not illustrated, that can be plastically modelled astride the nasal bone.

For the application of the mask to the face of the user, there are provided for two elastic rings 4, which are fixed to the sides of the screen 1 for attaching to the ears, or two straps for wrapping around the nape.

According to the distinctive characteristic of the invention, the filtering screen 1 of the mask is provided with a flexible adhesive element 5 projecting from the upper edge 1a thereof to form a tongue shaped appendage shaped so as to cover—in use—a substantial portion of the nose of the user, adhering thereto.

The adhesive element 5 conveniently has the flaccid consistency and characteristics of a common medical patch and, similarly to the latter, it is protected by one or two peel-off films prior to applying the mask.

The projecting appendage of the adhesive element 5 may also be provided with through perforations for skin perspiration, similar to those of patches.

In the case of surgical masks, whose filtering screen 1 consists, as mentioned, of at least three superimposed layers, the adhesive element 5 is partially inserted and fixed between these layers at the central region of the upper edge 1a of the screen 1. The fixing can be obtained with any suitable system, but more conveniently using the same adhesive surface of the lower part of the adhesive element 5 which, when manufacturing the mask, is inserted between the intermediate layer and the inner layer 3 and adhered thereto. In this manner, the adhesive element 5 becomes an integral part of the mask.

In use, following the application of the mask on the face of the user covering the nose and mouth with the filtering screen 1, the projecting appendage of the adhesive element 5 is adapted to the shape of the nasal bone and adhered against corresponding large regions of the nose. In this manner, the upper edge 1a of the filtering screen 1 is stably and effectively temporarily fixed to the nose, not only in the central part thereof but also along the opposite sides, keeping the entire upper region of the screen 1 adhering almost sealingly against the face. This drastically reduces the entry of ambient air through this region during inhalation, but above all it effectively eliminates the upward emission of the vapour contained in the exhalation flow, which prevents the bothersome fogging of the lenses in case the user wears glasses.

Obviously, the construction details and the embodiments may widely vary with respect to what has been described and illustrated, without departing from the scope of protection of the present invention as defined in the claims that follow.

1. A face protection mask comprising a flexible filtering screen shaped to cover a mouth and a nose of a user, said mask comprising:
an adhesive element projecting from an upper edge of the filtering screen and forming a flexible appendage configured to cover in use a substantial portion of the nose of the user, and the appendage configured for adhering to the nose.

2. Face protection mask according to claim 1, wherein the adhesive element forming said appendage has the characteristics of a medical patch.

3. Face protection mask according to claim 2, wherein the adhesive element forming said appendage is protected by peel-off films.

4. Face protection mask according to claim 1, wherein the filtering screen consists of superimposed layers joined together, and the adhesive element forming said appendage is inserted and fixed by adhesion between such layers.

5. Face protection mask according to claim 1, wherein said projecting appendage of the adhesive element is perforated.
